(19) United States
(12) Patent Application Publication
(10) Pub. No.: US 2022/0015871 A1
(43) Pub. Date: Jan. 20, 2022

(54) ANNULAR-SHAPED SUBPERIOSTEAL JAW IMPLANT

(71) Applicant: OMX Solutions Pty. Ltd., Melbourne (AU)

(72) Inventors: Aaron Atkinson, Melbourne (AU); George Dimitroulis, Melbourne (AU); Kevin Michael Shaddock, Melbourne (AU)

(73) Assignee: OMX Solutions Pty. Ltd., Melbourne (AU)

(21) Appl. No.: 16/932,684

(22) Filed: Jul. 17, 2020

(51) Int. Cl. A61C 8/00

(52) U.S. Cl. CPC A61C 8/003; A61C 8/0009; A61C 8/0069; A61C 8/0054; A61C 8/0027

(57) ABSTRACT

An anatomically-contoured subperiosteal jaw implant includes an annular-shaped baseplate and internal support arms corresponding to a location of a plurality of height-adjustable posts. The baseplate is configured for placement over the alveolar ridge of a mandible or maxilla bone and creates a plurality of internal apertures within the baseplate to minimize the impact on the alveolar ridge and improve re-attachment of bone and soft tissue revascularization after implant insertion. The baseplate is attached with the bone via a series of screws inserted through screw holes uniquely positioned throughout the baseplate based on individual anatomical models of a patient receiving the implant, and the height-adjustable posts are also shaped for partial insertion into the bone to reduce the height of the posts and attached dental component while also improving retention of the implant. The support arms absorb stress on the posts received via a chewing or grinding action of the jaw.

### BACKGROUND

### Field of the Invention

The embodiments described herein are related to subperiosteal jaw implants, and more particularly to an annular-shaped subperiosteal jaw implant for attaching over an alveolar ridge of a mandible or maxilla bone.

### Related Art

Dental rehabilitation following loss of teeth is achieved by removable dental prostheses (e.g., dentures) or fixed bridgework supported by osseo-integrated dental implants. Subperiosteal jaw implants were first conceived in the 1940's as large metal frames made of stainless steel or cobalt chrome that were passively placed directly onto the jawbone without any fixation. Instability of such devices was very high, as was the failure rate. In the 1960's and 1970's, screw fixation was introduced, but the devices yielded less than ideal outcomes because of the excessive size of the frame that required significant soft tissue stripping and the incompatibility of the materials used that reacted to the surrounding soft tissues, which finally led to the abandonment of the technique all together.

Recent improvements in additive manufacturing have led to the development of customizable subperiosteal jaw implants which have significantly improved upon the prior issues. However, existing implants still struggle to provide sufficient structural support while avoiding complications from failure of the implant to osseointegrate with the bone or allow tissue to reattach with bone structure around the implant.

### SUMMARY

Embodiments described herein include a subperiosteal jaw implant with an annular-shaped anatomically-contoured baseplate with internal support arms which correspond to a location of a plurality of height-adjustable and implantable posts. The annular baseplate is configured for placement over the alveolar ridge of a mandible or maxilla bone and forms a plurality of internal apertures within the baseplate and support arms to minimize the impact on the alveolar ridge and improve re-attachment of bone and tissue after implant insertion. The baseplate is attached with the bone via a series of screws inserted through screw holes uniquely positioned throughout the baseplate based on individual anatomical models of a patient receiving the implant, and the height-adjustable posts are shaped for partial insertion into the bone to reduce the height of the post and corresponding dental component while also improving retention of the implant. The internal support arms laterally bisect the annular baseplate and may be located at the same location as the posts in order to absorb stress on the connector received via a chewing or grinding action of the jaw.

In one embodiment of the invention, a subperiosteal jaw implant comprises: an annular baseplate anatomically contoured for attachment over an alveolar ridge of a mandible bone or maxilla bone; one or more support arms disposed laterally across the annular baseplate; and a plurality of posts formed within the annular baseplate or support arms, each post being formed to receive a dental component.

In another embodiment of the invention, a method of manufacturing a subperiosteal jaw implant comprises the steps of: forming an anatomically-contoured annular baseplate for attachment over an alveolar ridge of a mandible bone or maxilla bone; disposing one or more support arms laterally across the annular baseplate; and positioning a plurality of posts within the annular baseplate or support arms, each post being formed to receive a dental component.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a front-view illustration of an annular-shaped subperiosteal jaw implant, according to an embodiment of the invention;

FIG. 2 is a rear-view illustration of the annular-shaped subperiosteal jaw implant, according to an embodiment of the invention;

FIG. 3 is a bottom-view illustration of the annular-shaped subperiosteal jaw implant, according to an embodiment of the invention;

FIG. 4 is a side-view illustration of the annular-shaped subperiosteal jaw implant, according to one embodiment of the invention;

FIG. 5 is a front-view illustration of the annular-shaped subperiosteal jaw implant attached with a maxilla bone of a human, according to an embodiment of the invention;

FIG. 6 is a side-view illustration of the annular-shaped subperiosteal jaw implant attached with a maxilla bone of a human, according to an embodiment of the invention;

FIG. 7 is a front-view illustration of the annular-shaped subperiosteal jaw implant attached with a mandible bone of a human, according to an embodiment of the invention;

FIG. 8 is a side-view illustration of the annular-shaped subperiosteal jaw implant attached with a mandible bone of a human, according to an embodiment of the invention;

FIG. 9 is a rear-view illustration of the annular-shaped subperiosteal jaw implant attached with a maxilla bone of a human, according to an embodiment of the invention;

FIG. 10 is a side cutaway view of a conical post, according to an embodiment of the invention; and

FIG. 11 is a top-down view of the conical post showing a connector portion, according to one embodiment of the invention;

FIG. 12 is a side view of a cylindrical post, according to an embodiment of the invention; and

FIG. 13 is a side cutaway view of the cylindrical post, according to an embodiment of the invention; and

FIG. 14 is a side view of a hex head connector, according to one embodiment of the invention;

FIG. 15 is a side cutaway view of the hex head connector, according to one embodiment of the invention;

FIG. 16 is a flow diagram illustrating an example process for manufacturing the annular-shaped subperiosteal jaw implant, according to an embodiment of the invention.

### DETAILED DESCRIPTION

Certain embodiments disclosed herein provide for a subperiosteal jaw implant with an annular-shaped anatomically-contoured baseplate and internal support arms which correspond to a location of a plurality of height-adjustable and implantable posts. The annular baseplate is configured for placement over the alveolar ridge of a mandible or maxilla bone and forms a plurality of internal apertures within the baseplate and support arms to minimize the impact on the alveolar ridge and improve re-attachment of bone and tissue after implant insertion. The baseplate is attached with the bone via a series of screws inserted through screw holes uniquely positioned throughout the baseplate based on individual anatomical models of a patient receiving the implant, and the height-adjustable posts are also shaped for partial insertion into the bone to reduce the height of the post and corresponding dental components while also improving retention of the implant. The internal support arms laterally bisect the annular baseplate and may be located at the same position as the posts in order to absorb stress on the posts received via a chewing or grinding action of the jaw.

The subperiosteal jaw implant may be created using a three-dimensional medical image of a patient's bone structure in order to anatomically contour the implant to the individual patient. The implant may be created electronically via a software program which incorporates the 3D image of the bone to create a corresponding 3D image of the implant that can then be further customized to create exact measurements of all aspects of the baseplate, posts, support arms, etc. that will fit the patient's anatomy. The implant may then be additively-manufactured from a biocompatible material as a single piece to maximize the structural stability of the implant.

The overall annular shape of the baseplate is advantageous for minimizing the amount of foreign material which is attached to the surface area of the bone, thus allowing for maximum re-attachment of surrounding tissue to the bone while also providing for sufficient osseointegration of the implant with the bone. In particular, the annular shape avoids having the implant surface cover the majority of the alveolar ridge, allowing for revascularization of the soft tissue to better preserve the patient's bone structure and also to allow for the dispersal and distribution of any expected forces or loads through the implant by attachment to the adjacent portions of the maxilla or mandible bone.

Furthermore, by providing height-adjustable posts which may be integrated into the bone structure of the patient, the resulting dental components which are attached with the implant may sit closer to the bone structure and provide a better fit with more structural stability and less discomfort for the patient.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

I. Annular-Shaped Subperiosteal Jaw Implant

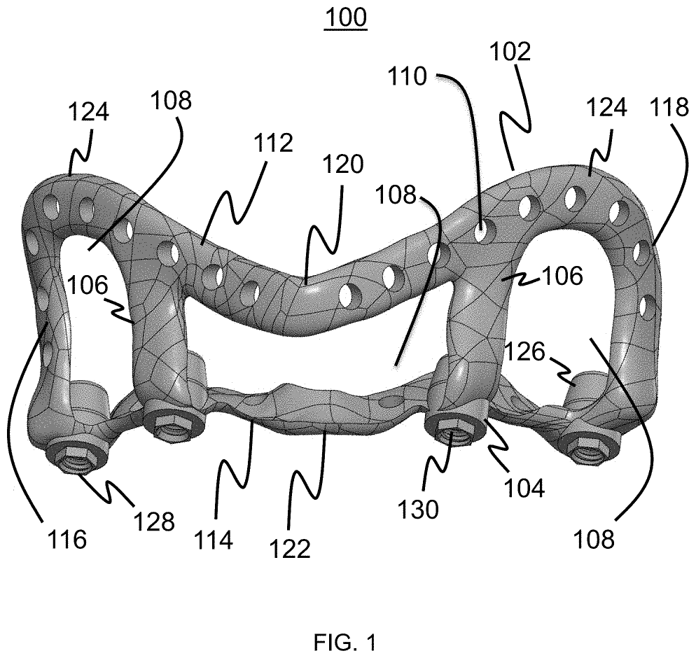

FIG. 1 is a front-view illustration of an annular-shaped subperiosteal jaw implant 100 for attaching with a maxilla bone, according to an embodiment of the invention. The implant 100 includes an annular-shaped baseplate 102 with a plurality of posts 104 disposed along one length of the baseplate closest to the alveolar ridge where an abutment or occlusal screw will be connected with a tooth or related dental structure. The baseplate 102 defines an aperture 108 and is configured so that one lengthwise side with a labial flange 112 and subralabial flanges 124 are be placed above the alveolar ridge, while an opposing lengthwise side with a lingual flange 114 will be placed immediately behind an alveolar ridge, such that the lateral sides 116 and 118 of the implant 100 are disposed across the alveolar ridge.

A plurality of support arms 106 are disposed laterally across the baseplate from one lengthwise side to another to bisect the primary aperture 108, in this case to connect a labial flange 112 with a lingual flange 114. The baseplate 102 is provided with a plurality of screw holes 110 which are configured to receive screws that will attach the baseplate to the underlying maxilla bone.

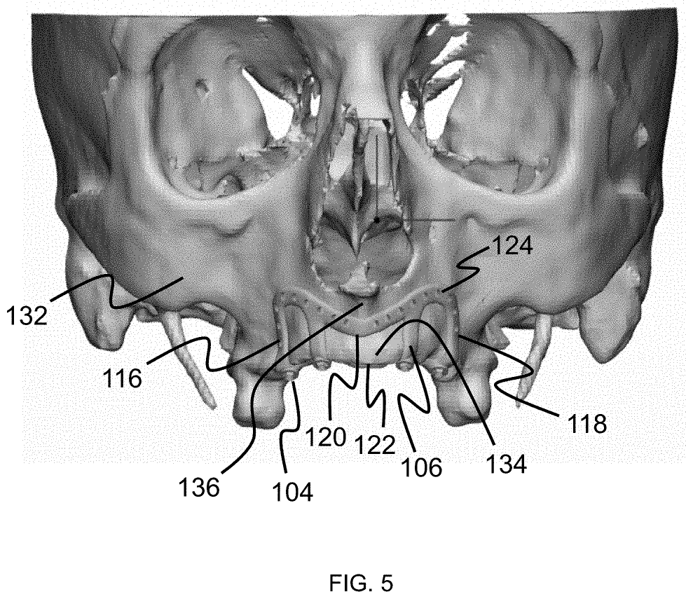

As noted above, a first lengthwise side of the baseplate 102 includes the labial flange 112 in a central portion of the lengthwise side with the supralabial flanges 124 on either side of the labial flange 112. The labial flange 112 may have an angled surface which angles the baseplate downward in a v-shaped fashion to avoid a nasal cavity of the patient, as shown more clearly in FIG. 5. In particular, a diameter of the labial flange may be narrowed at a labial center portion 120 to safely avoid the nasal cavity. The v-shape then continues in an upward direction from the center portion 120 to the supralabial flanges 124, which are configured for connection with the maxilla bone closer to the orbital bone.

Similarly, the second lengthwise side of the baseplate 102 nearer to the alveolar ridge includes the lingual flange 114 which is also configured to retain the posts 104. Similarly to the labial flange 112, the lingual flange 114 may also have a narrowed lingual center portion 122. The posts 104 in the lingual flange 114 are essentially configured between the lingual flange 114 and the support arms 106 such that one side of the posts 104 is supported by the lingual flange 114 while an opposing side of the posts 104 is supported by the support arms 106, the support arms extending from the posts 104 to the opposing labial flange 112 and bisecting the aperture 108 of the annular baseplate 102 to form a plurality of apertures 108.

As is also shown in FIG. 1, the posts 104 has a substantially cylindrical shape but may include a conical-shaped lower portion 126 which is configured for insertion into the bone. By inserting the conical-shaped lower portion 126 into the bone, the posts 104 can be configured at a lower height relative to the baseplate 102 to allow for an abutment or occlusal screw to also be attached at a lower position. This configuration is advantageous in many situations where a dental component (such as an abutment) may otherwise sit too far away from the bone structure and create discomfort and an awkward fit for the patient. Furthermore, the insertion of a portion of the coupling post into the bone will provide additional structural stability for the coupling post and the overall implant. Since the posts can be customized to a patient's anatomy in the same way that the overall baseplate can be customized to the patient's anatomy, the vertical position of each coupling post 104 may be individually adjusted during the design process to provide an ideal position for each coupling post and corresponding dental component. Furthermore, the overall size of the coupling post 104 may be customized to ensure that an appropriate length of the conical shape 126 is inserted into the bone while an appropriate length of the main body of the coupling post 104 extends outward to the desired placement point for the dental component. In one embodiment, the height of the posts 104 may be approximately 3 mm-9 mm.

The post 104 further includes a top connector portion 128 with a hex nut and threaded portion 130 for insertion and attachment of a corresponding dental component. As the entire post 104 may be customized for any type of abutment or occlusal screw, the post may be configured with a universal connector and may be formed with other types of insertion shapes or configurations.

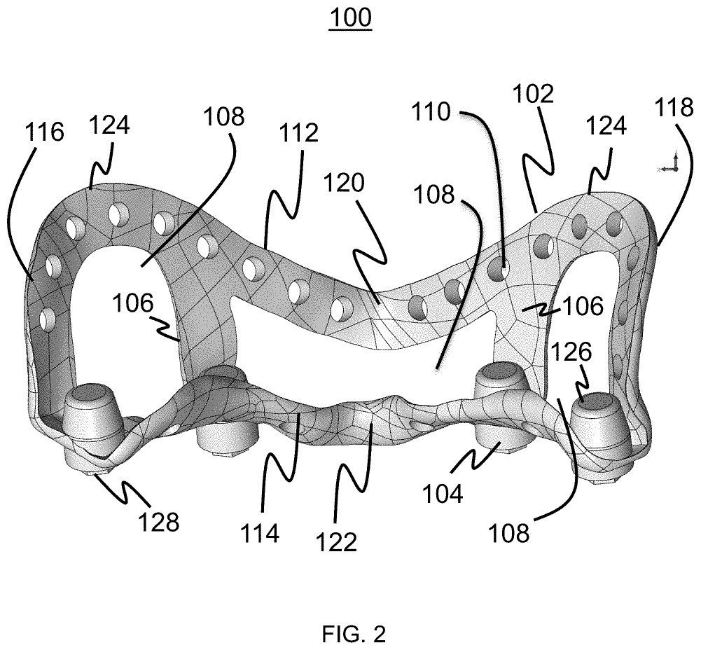

FIG. 2 is a rear-view illustration of the annular-shaped subperiosteal jaw implant which more clearly shows the different angles and overall shape of the baseplate 102, position of the connectors 104 and shape and position of the support arms 106. It will be appreciated from this viewpoint that the entirety of the baseplate 102 is anatomically-contoured to fit the exact bone anatomy of the patient and will have minor variations in the overall shape and diameter each time the implant is manufactured. In one embodiment, the thickness of the baseplate is approximately 1.1 millimeters (mm), but the thickness may range from approximately 0.9 mm-1.5 mm to accommodate for individual anatomy and the need for more or less structural support in certain areas of the baseplate. In one embodiment, a width of the baseplate may range from approximately 3.0 mm-5.5 mm, primarily depending on the placement of the screw holes 110 for the screws, as the screw holes generally have an approximate diameter of 2 mm, but the diameter may range from 1.7 to 2.3 mm to accommodate individual anatomy and location requirements, based on a screw diameter of approximately 1.7 mm, but the screw diameter may range from 1.5 to 2.0 mm to accommodate individual anatomy, location requirements and types of screws to be used. In one embodiment, the width of the baseplate 102 on each side of the screw hole 110 is approximately 1 mm, and the spacing between each screw hole 110 is approximately 0.8 mm-2.2 mm.

It should also be noted that the baseplate is typically configured with a plurality of screw holes 110 which may not be needed but which are created during the manufacturing process to provide as many options for attachment of the baseplate to the bone as possible. The placement of each screw hole may be customized based on the anatomical structure of the patient's bone and to avoid areas where attachment may be problematic—for example where nerves or deteriorated bone structure exist. Although not illustrated herein, screw holes may be formed on the support arms 106 if needed for attachment to certain portions of the bone.

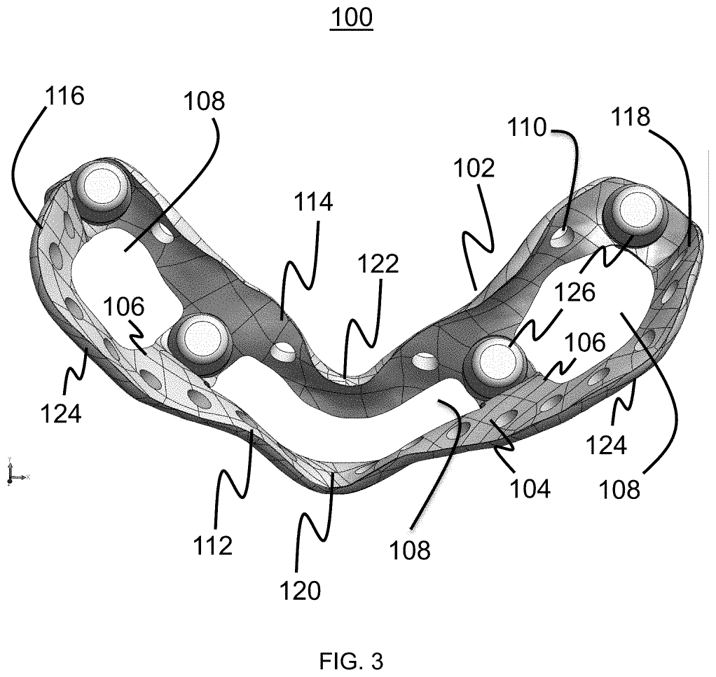

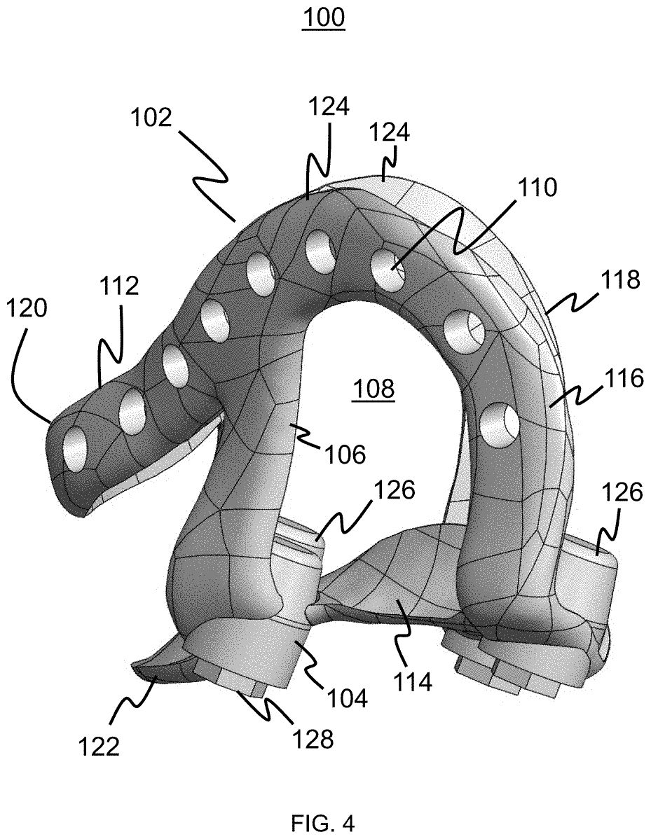

FIG. 3 is a bottom-view illustration of the annular-shaped subperiosteal jaw implant 100 which further illustrates the thickness of the baseplate 102 and the position of the coupling post 104 in relation to the lingual flange 114 and adjacent support arms 106. FIG. 4 is a side-view illustration of the annular-shaped subperiosteal jaw implant 100 which further illustrates the shape of the labial flange 112 and corresponding supralabial flanges 124 as they form the v-shape and curve upward and outward away from the labial narrowing portion 120. This illustration also shows the angle of the coupling post 104, which can each be individually customized and manufactured together with the baseplate 102 to ensure maximum structural support.

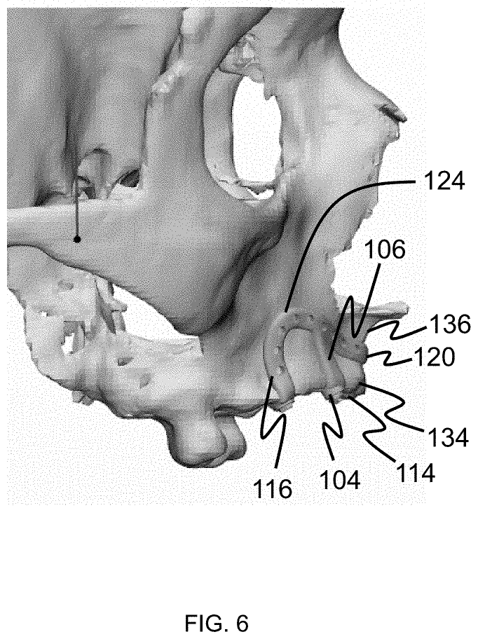

FIG. 5 is a front-view illustration of the annular-shaped subperiosteal jaw implant attached with a maxilla bone 132 of a human, according to an embodiment of the invention. In particular, the lengthwise side of the baseplate 104 with the labial narrowing portion 120 is shown to illustrate the structural basis for avoiding the nasal cavity 136, where the baseplate 104 angles upward and outward toward the orbital bone as the baseplate curves from the labial narrowing portion to the supralabial flanges 124. The left lateral side 116 and right lateral side 118 of the baseplate 102 are also illustrated as they extend over the alveolar ridge 134, similarly to the shape and extension of the support arms 106. The posts 104 are similarly shown near the alveolar ridge and positioned immediately adjacent to the lateral sides 116, 117 and support arms 106 for maximum structural support. FIG. 6 is a side-view illustration of the annular-shaped subperiosteal jaw implant attached with a maxilla bone of a human, providing an additional viewpoint of the anatomically-contoured annular shape of the baseplate 102 as the supralabial flange 124 angles over the maxilla bone and curves downward toward the labial narrowing portion 120 to avoid the nasal cavity 136. The position of the lingual flange 114 relative to the alveolar ridge 134 is also more apparent in this illustration, demonstrating how the overall annular shape avoids covering the alveolar ridge to provide for greater reattachment of tissue with the bone to preserve the bone structure, revascularize the soft tissue and improve the reliability and long-term function and viability of the implant.

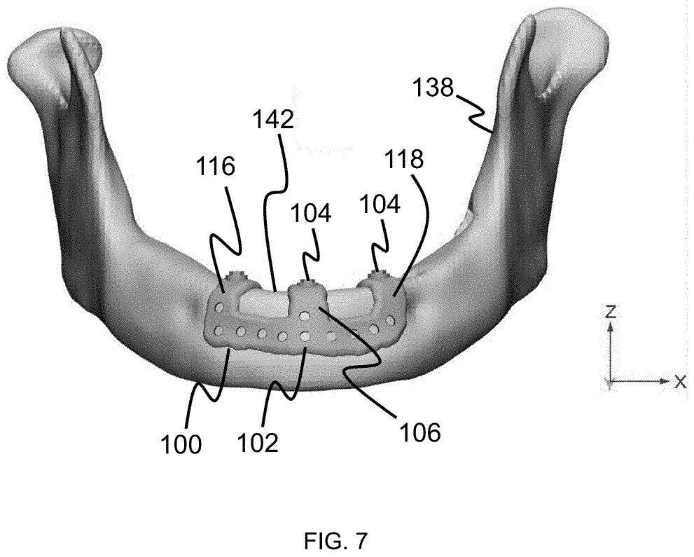

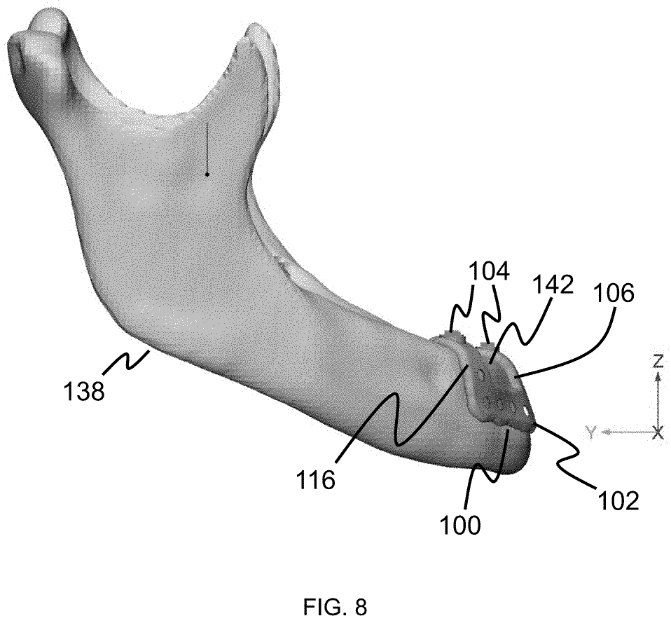

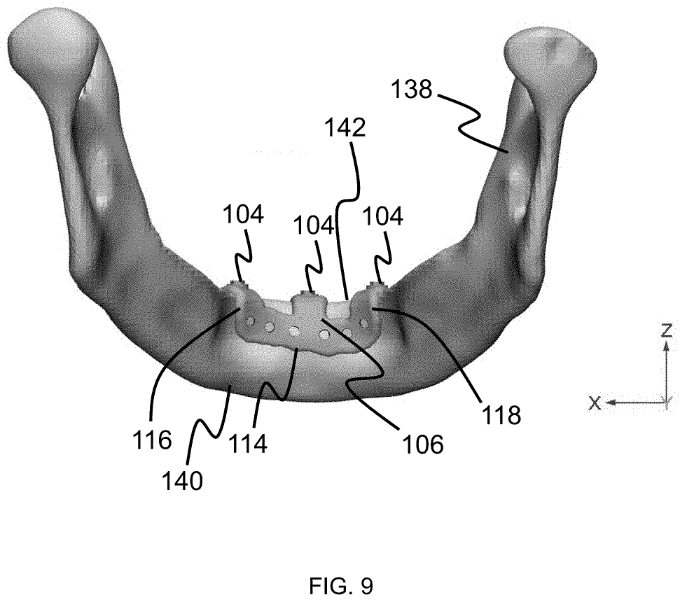

FIG. 7 is a front-view illustration of the annular-shaped subperiosteal jaw implant 100 attached with a mandible bone 138 of a human, according to an embodiment of the invention. In this embodiment, the implant is configured with only three posts 104, and as a result, only one support arm 106 is provided across the alveolar ridge 142 in addition to the left lateral side 116 and right lateral side 118 of the baseplate. Although the shape of the baseplate is more uniform in the mandibular version, it still may require minor adjustments in the curvature, width and diameter in order to accommodate for the position of nerves, bone loss and other anatomical issues. FIG. 8 is a side-view illustration of the annular-shaped subperiosteal jaw implant attached with the mandible bone 138 further illustrating the overall anatomically-contoured shape of the baseplate 102 along with the lateral curvature of the left lateral side 116 and support arm 106. In this embodiment, the posts 104 are placed more clearly directly over the alveolar ridge 142 of the mandible bone. Finally, FIG. 9 is a rear-view illustration of the annular-shaped subperiosteal jaw implant 100, illustrating how the posts 104 are placed more along the lateral sides 116, 118 and support arms 106 than on the lingual flange 114.

II. Height-Adjustable Posts

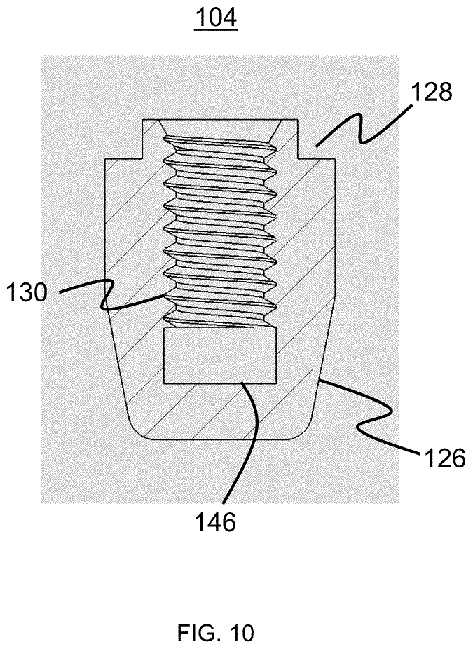

FIG. 10 is a cutaway side view of the post 104 illustrating the overall shape, including the conical-shaped lower end 126 for insertion into the bone, the dental component connector 128 at the upper end of the post, the threaded cavity 130 for insertion of the abutment and a void 146. The dental component connector 128 may be formed into any shape needed to interface with an abutment or other connector. The void 146 is provided at a distal end of the threaded cavity 130 to allow for efficient manufacturing of the post and to provide sufficient space for the eventual insertion of the dental component connector 128. In this embodiment, the width and dimensions of the post may vary, as mentioned above, depending on the position of the post and the desired height of the dental component and overall denture being attached with the implant.

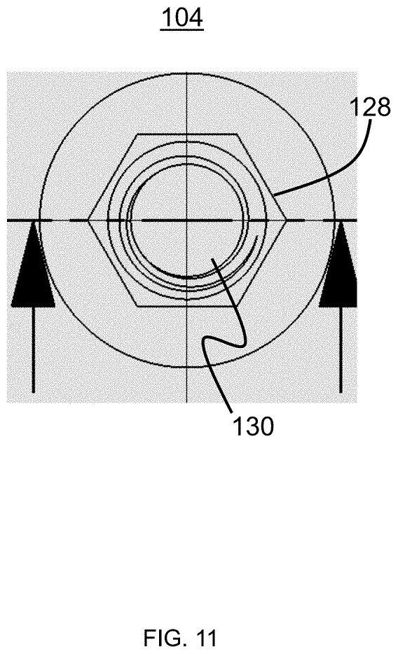

FIG. 11 is a top-down view of the post 104 with an external hex head connector 128 positioned around the cavity 130 for connection with and insertion of the dental component. In this embodiment, the overall diameter of the post 104 is approximately 4.1 mm, with the diameter of the hex head connector 128 being approximately 2.4 mm, although the range of the diameter of the connector may vary from approximately 2.1 mm to approximately 4.8 mm.

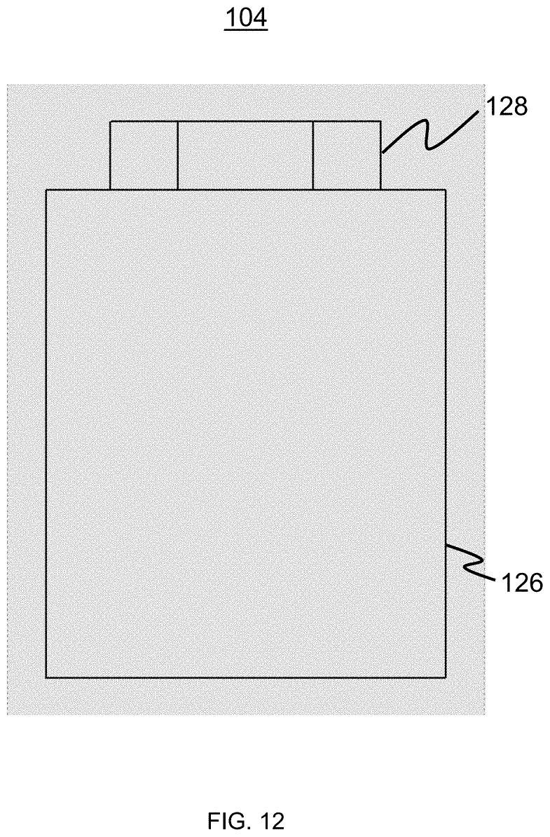

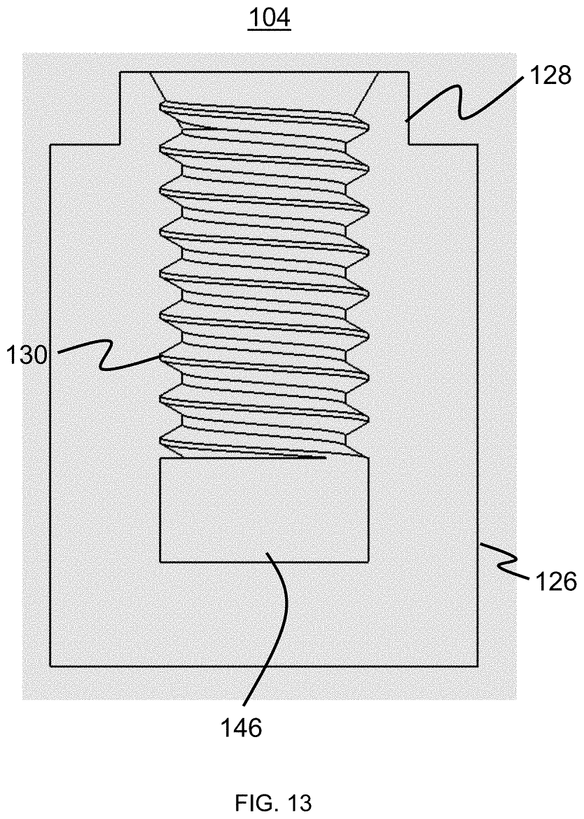

FIG. 12 is a side view of a cylindrical the post 104, including a cylindrical-shaped lower end 126 for insertion into the bone. Similarly to the previous embodiment of the post 104, the dental component adapter 128 is positioned on the upper surface of the post 104. FIG. 13 illustrates a cutaway side view of the cylindrical post 104 illustrating the threaded cavity 130 for insertion of the abutment and the void 146. In this embodiment, as mentioned above, the width and dimensions of the post may vary depending on the position of the post and the desired height of dental component and overall denture being attached with the implant.

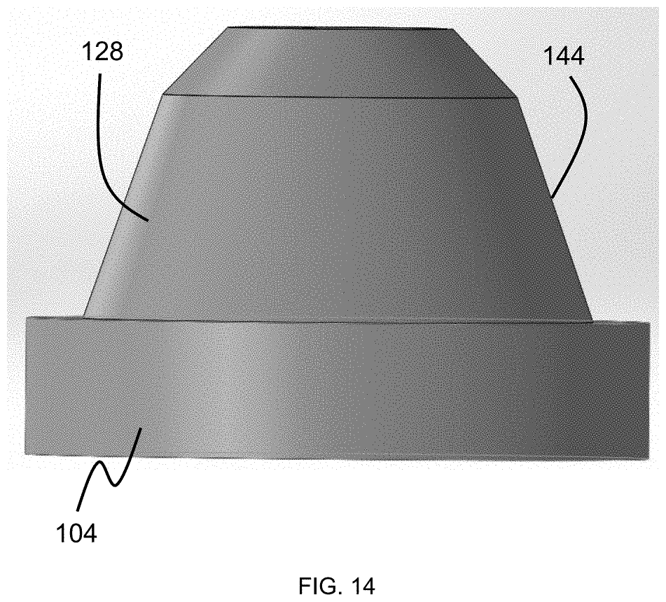

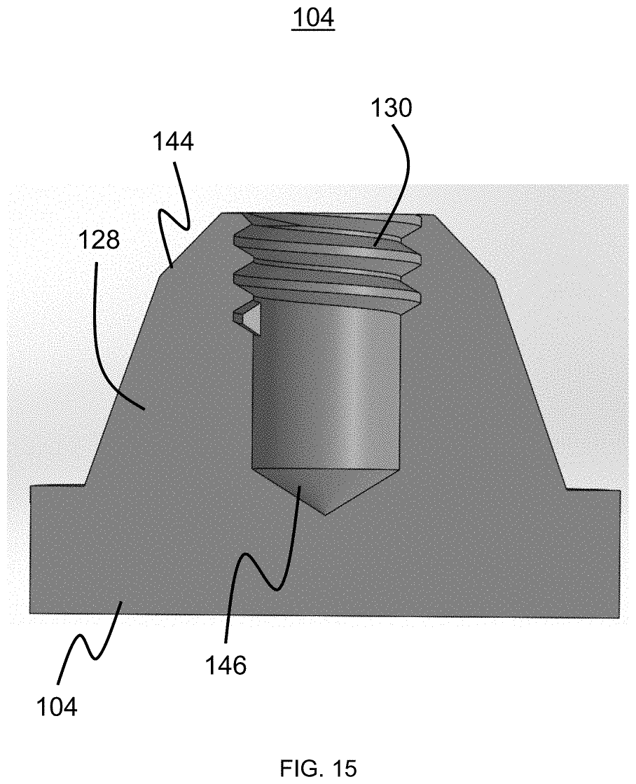

To further illustrate how any type of dental component connector may be positioned on the upper end of the post, FIG. 14 illustrates a connector 128 positioned on a top portion of the post 104, the connector 128 having a conical-shaped outer surface 144. FIG. 15 is a cutaway view of the connector 128 showing the threaded cavity 130 within the connector 128 for inserting a threaded abutment or occlusal screw. In this embodiment, the void 146 is provided at a distal end of the threaded cavity 130 to allow for the more efficient manufacturing of the post and to provide sufficient space for the eventual insertion of the threaded abutment or occlusal screw.

III. Method of Manufacture

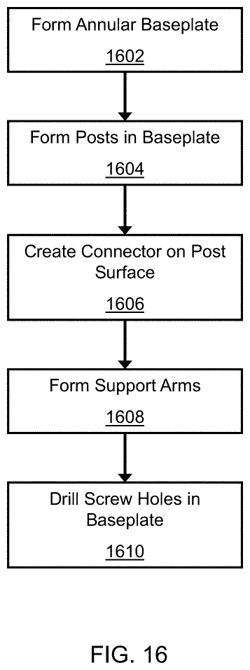

FIG. 16 is a flow diagram illustrating an example process for additively manufacturing the annular-shaped subperiosteal jaw implant, according to an embodiment of the invention. In a first step 1602, the annular baseplate is formed in a shape which is anatomically-contoured to an individual patient. In step 1604, one or more posts are formed within the annular baseplate, with each post being formed with a specific length and connected with the baseplate at a specific position in relation to the length of the post to provide for individualized heights of the corresponding connectors. In step 1606, a customized connector is formed on an upper surface of the post to correspond with a dental component being attached to the implant. In step 1608, one or more support arms are formed across the apertures of the annular baseplate, preferably adjacent to and potentially incorporating the one or more posts. In step 1610, screw holes are formed in the baseplate and/or support arms for insertion of a screw used to attach the baseplate to the patient's bone.

As mentioned above, the subperiosteal jaw implant may be additively-manufactured from a biocompatible material so that each implant is anatomically-contoured to an individual patient.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A subperiosteal jaw implant, comprising:
an annular baseplate anatomically contoured for attachment over an alveolar ridge of a mandible bone or maxilla bone;
one or more support arms disposed laterally across the annular baseplate; and
a plurality of posts formed within the annular baseplate or support arms, each post being formed to receive a dental component.

2. The subperiosteal jaw implant of claim 1, wherein a vertical position of each post in relation to the baseplate may be customized based on a desired height of the dental component being attached with each post.

3. The subperiosteal jaw implant of claim 2, wherein a base portion of at least one post is shaped for partial insertion into the mandible or maxilla bone.

4. The subperiosteal jaw implant of claim 3, wherein the base portion of the at least one post is conically-shaped.

5. The subperiosteal jaw implant of claim 1, wherein a top portion of each post includes a connector configured to receive the dental component.

6. The subperiosteal jaw implant of claim 1, wherein each of the one or more support arms is positioned approximately adjacent with one of the plurality of posts.

7. The subperiosteal jaw implant of claim 6, wherein the annular baseplate includes approximately four posts and approximately two support arms.

8. The subperiosteal jaw implant of claim 1, wherein the annular baseplate includes a plurality of screw holes for insertion of screws to attach the baseplate with the mandible bone or maxilla bone, and wherein the screw holes are positioned based on a bone structure of the mandible bone or maxilla bone.

9. The subperiosteal jaw implant of claim 1, wherein the baseplate includes a labial flange with a narrowed-diameter.

10. The subperiosteal jaw implant of claim 1, wherein the baseplate includes a lingual flange with a narrowed-diameter.

11. The subperiosteal jaw implant of claim 1, wherein the baseplate includes a supralabial flange on both sides of the labial flange for attachment with an orbital bone.

12. The subperiosteal jaw implant of claim 1, wherein the baseplate has a thickness of approximately 0.8 to approximately 3 millimeters (mm).

13. The subperiosteal jaw implant of claim 1, wherein the jaw implant is additively manufactured using a biocompatible material.

14. A method of manufacturing a subperiosteal jaw implant, comprising the steps of:
forming an anatomically-contoured annular baseplate for attachment over an alveolar ridge of a mandible bone or maxilla bone;
disposing one or more support arms laterally across the annular baseplate; and
positioning a plurality of posts within the annular baseplate or support arms, each post being formed to receive a dental component.

15. The method of claim 14, further comprising positioning each of the plurality of posts at a vertical position in relation to the baseplate based on a desired height of the dental component being attached with each post.

16. The method of claim 12, further comprising shaping a base portion of at least one post into a shape for partial insertion into the mandible or maxilla bone.

17. The method of claim 16, further comprising shaping the base portion of each post into a conical shape.

18. The method of claim 14, further comprising forming a connector on a top portion of each post, the connector being configured to receive the dental component.

19. The method of claim 14, further comprising disposing the one or more support arms approximately adjacent with one of the plurality of posts.

20. The method of claim 14, further comprising positioning approximately four posts within the annular baseplate.

21. The method of claim 20, further comprising disposing approximately two support arms across the annular baseplate.

22. The method of claim 14, further comprising disposing a plurality of screw holes in the annular baseplate based on a bone structure of the mandible bone or maxilla bone.

23. The method of claim 14, further comprising forming the baseplate with a narrowed-diameter portion pertaining to a labial flange.

24. The method of claim 14, further comprising forming the baseplate with a narrowed-diameter portion pertaining to a lingual flange.

25. The method of claim 23, further comprising forming a suupralabial flange adjacent each side of the labial flange for attachment with an orbital bone.

26. The method of claim 14, further comprising forming the baseplate with a thickness of approximately 0.8 to approximately 3 millimeters (mm).

27. The method of claim 14, further comprising forming the subperiosteal jaw implant via additive manufacturing using a biocompatible material.
